(19) United States
(12) Patent Application Publication
(10) Pub. No.: US 2015/0356171 A1
(43) Pub. Date: Dec. 10, 2015

(54) SYSTEM AND METHOD FOR CROSS-CLOUD TOPIC MATCHING

(71) Applicant: Harmon.ie R&D Ltd., Lod (IL)

(72) Inventor: Roy Sheinfeld, Tel Aviv (IL)

(73) Assignee: Harmon.ie R&D Ltd., Lod (IL)

(21) Appl. No.: 14/724,141

(22) Filed: May 28, 2015

Related U.S. Application Data
(60) Provisional application No. 62/007,979, filed on Jun. 5, 2014.

(51) Int. Cl. G06F 17/30

(52) U.S. Cl. CPC G06F 17/30675; G06F 17/3071; G06F 17/30864

(57) ABSTRACT

A system and method for cross-cloud topic matching. The method comprises: receiving unstructured data as a collection of unstructured data portions; analyzing each of the unstructured data portions to identify at least one tag in each unstructured data portion; determining a topic for each unstructured data portion based on the identified at least one tag; analyzing the determined topics to identify at least one match between the topics; and generating at least one searchable term respective of the at least one match.

### CROSS-REFERENCE TO RELATED APPLICATIONS

This application claims the benefit of U.S. Provisional Application No. 62/007,979 filed on Jun. 5, 2014, the contents of which are hereby incorporated by reference.

### TECHNICAL FIELD

The present disclosure relates generally to systems for analyzing contextual data, and more particularly to systems and methods for analyzing contextual data existing in cloud sources and generating searchable topics respective thereof.

### BACKGROUND

A significant problem faced by enterprises' workers is making sense of the sheer volume of information being delivered on a regular basis. The adoption of multiple cloud services is exacerbating the problem because now information is not only abundant, but it is also disconnected. The result is worker information overload and stress.

The most effective way to eliminate information overload and make workers productive is to present workers with the most relevant and important information and filter out the rest. The most effective way to filter information is to apply context to information streams.

The personal context provided by calendar applications includes free-text fields to describe the purpose of an event (i.e. event description). Text in this field usually relates directly to information stored in other applications, such as CRM, SalesForce® Automation, or Document Management Systems. The difficulty of extracting the text information from the calendar event and correlating it to structured data in multiple, operational applications is a complex, manual cognitive process. In particular, certain contexts may be missed entirely if a worker fails to search specifically for the correct key words.

In the best case, the worker suffers from information overload. In most cases, the correlations are overlooked, thereby leading to poor business execution and costly mistakes as the worker misses critical information. Existing solutions lack the ability to properly identify topical contexts of information streams that may be associated with various combinations of text inputs.

It would therefore be advantageous to provide a solution that would overcome the deficiencies of the prior art by providing cross-cloud topic matching.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Certain embodiments described herein include a method for cross-cloud topic matching. The method comprises: receiving unstructured data as a collection of unstructured data portions; analyzing each of the unstructured data portions to identify at least one tag in each unstructured data portion; determining a topic for each unstructured data portion based on the identified at least one tag; analyzing the determined topics to identify at least one match between the topics; and generating at least one searchable term respective of the at least one match.

Certain embodiments disclosed herein include a system for cross-cloud topic matching. The system comprises: a processing unit; and a memory, the memory containing instructions that, when executed by the processing unit, configure the system to: receive unstructured data including at least one unstructured data portion; analyze each unstructured data portion to identify at least one tag in each unstructured data portion; determine a topic for each unstructured data portion based on the identified at least one tag; analyze the determined topics to identify at least one match between the topics; and generate at least one searchable term respective of the at least one match.

Certain embodiments disclosed herein include an agent for cross-cloud topic matching. The agent comprises: a network interface for receiving and sending unstructured data, the unstructured data including at least one portion of unstructured data; an analyzing unit for identifying at least one tag respective of each portion of the unstructured data; a topic determination unit for generating at least one topic respective of each portion of unstructured data; and a term generator for generating at least one searchable term based on matches between the topics.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic diagram of a system used to describe the various disclosed embodiments.

FIG. 2 is a schematic diagram illustrating an agent installed on a client node according to an embodiment.

FIG. 3 is a flowchart illustrating a method for cross-cloud topic matching according to an embodiment.

FIG. 4 is a flowchart illustrating a method for generating topics according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

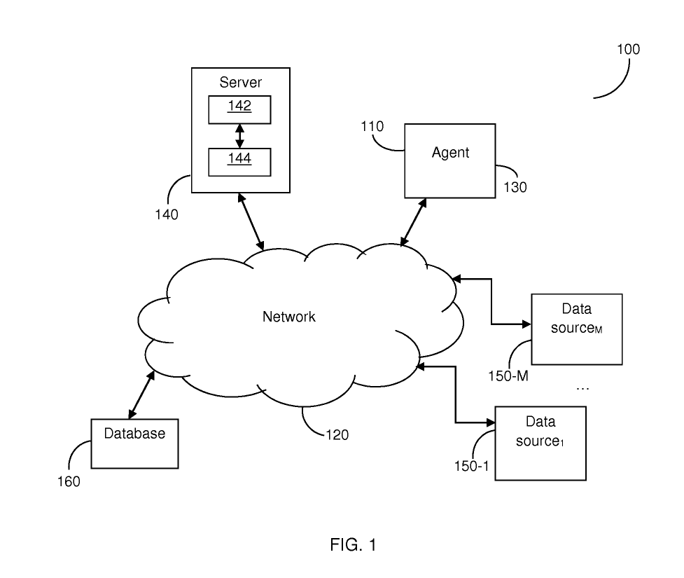

FIG. 1 shows an exemplary and non-limiting block diagram of a network system 100 utilized to describe various disclosed embodiments. A client node 110 is communicatively connected to a network 120. The client node 110 may be, but is not limited to, a personal computer, a tablet computer, a laptop computer, a smart phone, a wearable computing device, and so on. The network 120 may be a wireless, cellular, or wired network, a local area network (LAN), a wide area network (WAN), a metro area network (MAN), the Internet, the worldwide web (WWW), and any combination thereof.

The client node includes an agent 130 installed therein. The agent 130 may be implemented as an application program having instructions that reside in a memory of its respective client node. The agent 130 is further communicatively connected to a server 140 over the network 120. It should be noted that a single client node 110 and agent 130 is shown in FIG. 1 merely for simplicity purposes and without limitation on the disclosed embodiments. Multiple client nodes 110 and/or agents 130 may be utilized without departing from the scope of the disclosure.

According to one embodiment, the agent 130 monitors a plurality of cloud-based data resources 150-1 through 150-M accessed by or through the respective client node 110, where M is an integer having a value greater than or equal to 1. The cloud-based data resources 150 may include, but are not limited to, social networks, enterprise networks, chat applications, and so on, with which the client node 110 communicates. Each agent 130 is further configured to collect unstructured data existing in the cloud-based data resources 150. The agent 130 is configured to send the collected data to the server 140 over the network 120. The unstructured data includes information that either does not have a pre-defined data model or is not organized in a pre-defined manner. Unstructured information is typically text-heavy, but may contain data such as dates, numbers, and facts as well. For example, unstructured data may include, but is not limited to, a document, a message (e.g., an email message, chat correspondence, or SMS messaging), images, video clips, calendar event descriptions, and combinations thereof.

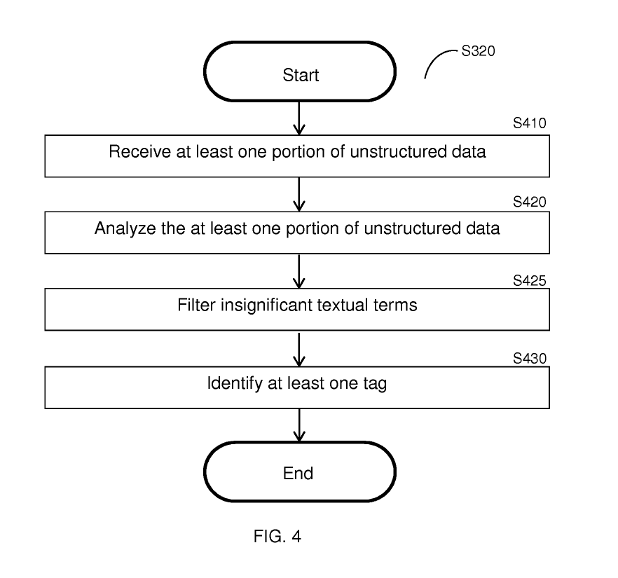

The unstructured data is analyzed by the server 140 to identify at least one tag for each portion of the unstructured data. A tag is a predetermined index assigned to a textual term. It should be noted that one or more tags can be generated for the same term. Identification of tags is described further herein below with respect to FIG. 4.

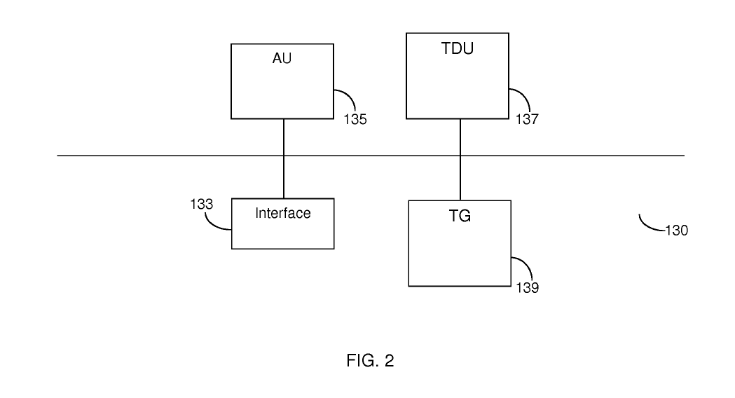

Based on the tags identified, the server 140 is configured to generate at least one topic of each portion of the collected unstructured data. The topic is a descriptive contextual term that indicates the context of a certain portion of the unstructured data. The topics are analyzed by the server 140 to identify at least one match between the topics. Respective of each match, at least one term is generated. The generated term is searchable by the client node 110. The generation of the term may further include correlating the identified topics and selecting the most descriptive term respective of the correlation. The selection is performed respective of a statistical analysis, a semantic analysis of the portions of the contexts, or a combination thereof. The term is then stored in a database 160 for further use. According to another embodiment, the term(s) are generated by the agent 130 as further described herein below with respect of FIG. 2.

Upon receiving a query from a client node 110 by the server 140, the query is matched to the at least one term existing in the database 160. Respective of a match, data respective of the topics that matches the term is provided to the client node 110.

In an embodiment, the server 140 typically includes a processing system 142 connected to a memory 144. The memory 144 contains a plurality of instructions that are executed by the processing system 142. Specifically, the memory 144 may include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The processing system 142 may comprise or be a component of a larger processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

FIG. 2 depicts an exemplary and non-limiting schematic diagram of the agent 130 installed on the client node 110 according to an embodiment. The agent 130 comprises an interface 133 through which unstructured data is received and sent over the network 120. The unstructured data is analyzed by an analyzing unit 135 to identify at least one tag for the unstructured data. The agent 130 further comprises a topic determination unit (TDU) 137. The TDU 137 is configured to generate at least one topic respective of each portion of the unstructured data based on the at least one tag. The topics are used by a term generator 139 to generate at least one term respective of each match between the topics.

In another embodiment, the agent 130 can operate and be implemented as a stand-alone program or, alternatively, can communicate and be integrated with other programs or applications executed in the client device 110. For example, the agent 130 may be an add-on or a plug-in installed in a web browser.

In another embodiment, each, some, or all of the modules or units of the agent 130 may be implemented with one or more processors. The one or more processors may include also machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the agent 130 and/or the client device 110 to perform the various functions described herein.

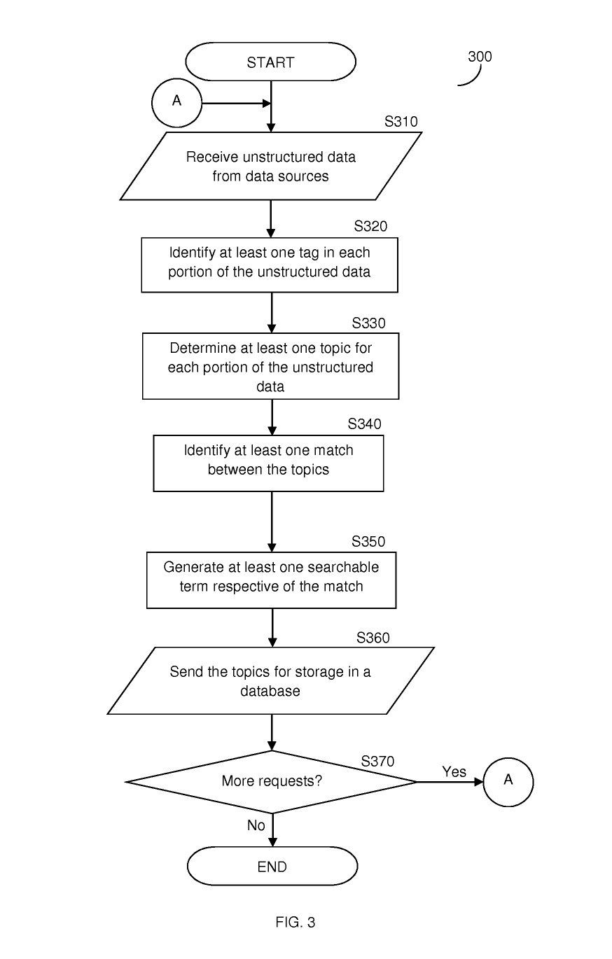

FIG. 3 depicts an exemplary and non-limiting flowchart 300 illustrating a method for cross-cloud topics matching according to an embodiment. In an embodiment, the method is performed by a server (e.g., the server 140). In another embodiment, the method may be performed by an agent (e.g., the agent 130) installed on a client device (e.g., the client device 110). In S310, unstructured data is collected from one or more cloud-based data sources (e.g., the cloud-based data sources 150). According to another embodiment, the unstructured data is collected by an agent (e.g., the agent 130) and sent to the server. In S320, at least one tag in the unstructured data is identified by the server.

In S330, at least one topic is determined by the server for each portion of the unstructured data based on the at least one tag. In an embodiment, the at least one tag is compared to a plurality of combinations of tags to determine at least one context. A combination of tags includes one or more tags. Each combination of tags is associated with a context. For example, a combination of the tags “meeting” and “accounts department” may be associated with the context “meeting with the accounts department.” Such a context will be determined if the combination of tags associated with the context matches the at least one tag. In an embodiment, the at least one context may further be determined based on the source of the unstructured data. As a non-limiting example, a context that is determined based on unstructured data retrieved from a calendar may be determined to be related to a meeting or other scheduled event.

A topic is determined based on the context. The topic is a descriptive contextual term that indicates the context of the portion of unstructured data. The topic may be, but is not limited to, a textual representation of the context.

In S340, the determined topics are analyzed and at least one match is identified respective of the analysis. The analysis may include, but is not limited to, determining if any portions of the determined topics match or are related. As a non-limited example, two topics, “employee training” and “new software training” match in that they both include “training.” Portions of topics may be related if, e.g., the portions are synonyms in the particular context (e.g., “training” and “practice” may be considered synonymous with regard to employees learning new skills), if one term is a generic term for another (e.g., the name of a law firm may be a particular instance of the generic terms “law firm,” “firm,” “lawyers,” “attorneys,” etc.), the portions are different spellings of the same word (e.g., “color” and “colour”), and so on.

In S350, at least one searchable term is generated respective of each match between the topics. The at least one searchable term is to be used by a user for retrieving all topics associated with the intent of the user. Therefore, the term typically includes all terms or portions thereof associated with the matching topics. The searchable term may include, but is not limited to, each portion of the determined topics. In an embodiment, the searchable term excludes any repetitions of matching portions of the determined topics. As a non-limiting example, a searchable term for the topics “employee training” and “new software training” may be “training employees to use new software.”

In S360, the generated term(s) are stored for further use. In S370, it is checked whether there are more requests and if so, execution continues with S310; otherwise, execution terminates.

As a non-limiting example, two portions of unstructured data are collected from two cloud based data sources 150. The unstructured data is analyzed and two tags are identified in each portion of the unstructured data. The two tags identified in the first portion of the unstructured data are “loan” and “Bank.” The two tags identified in the second portion of the unstructured data are “agreement” and “Bank of America Merrill Lynch®”. The topic of the first portion is determined as a loan from a bank and the topic of the second portion is determined as an agreement with Bank of America Merrill Lynch®. Both topics are analyzed and a match is identified respective thereto. Respective of the match, a term “loan agreement with Bank of America Merrill Lynch®” is generated and stored in the database 160. Upon receiving a search query that matches the term, for example, “Merrill Lynch agreement” from a client node 110, both portions of the unstructured data are provided to the client node 110.

FIG. 4 is an exemplary and non-limiting flowchart S320 illustrating identifying tags based on unstructured data according to an embodiment. In S410, at least one portion of unstructured data is received. The unstructured data may include, but is not limited to, a document, a message (e.g., an email message, chat correspondence, or SMS messaging), images, video clips, calendar event descriptions, and combinations thereof.

In S420, the at least one portion of unstructured data is analyzed to determine at least one textual term within the at least one portion of unstructured data. The analysis may include, but is not limited to, identifying textual terms in the at least one portion of unstructured data, identifying metadata associated with the unstructured data as textual terms, identifying portions of the unstructured data as associated with particular textual terms (e.g., the textual terms “pencil” and “eraser” may be associated with a pencil and eraser appearing in an image), and so on.

In optional S425, textual terms that do not provide significant contextual information may be filtered out from the at least one textual term. Such insignificant textual terms may include functional words such as “and,” “the,” “is,” “at,” “which,” “on,” and so on. This filtration optimizes tag identification by eliminating the need to identify tags for terms that will not be useful in determining topics. In an embodiment, a list of insignificant textual terms may be stored in a database. In such an embodiment, the at least one textual term may be compared to the stored list to determine which, if any, of the at least one textual term is insignificant.

In S430, at least one tag is identified based on the at least one textual term, wherein each tag is a predetermined index assigned to at least one of the textual terms. In an embodiment, the assignment of tags to textual terms may be stored in, e.g., a database. In various embodiments, multiple tags may be assigned to any or all textual terms. In an embodiment, if no tag is assigned to a particular textual term, a tag may be generated and identified for that textual term. In such an embodiment, the generated tag may be stored in the database as assigned to the textual term.

As a non-limiting example, a portion of an email message discussing a company picnic for XYZ Corporation is received. In this example, the portion of the email message is the body of the email (as opposed to the subject, sender, recipient, and so on). The body of the email is analyzed to identify the sentence “Please come to the XYZ Corporation picnic this Saturday at noon!” Terms that do not provide significant contextual information are filtered out, thereby leaving only the terms “company,” “picnic,” “Saturday,” and “noon.” The tags “company,” “leisure event,” “Saturday,” and “12:00 P.M.” are identified respective thereto. These tags may be representative of the topic “company leisure event on Saturday at 12:00 P.M.”

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for cross-cloud topic matching, comprising:
receiving unstructured data as a collection of unstructured data portions;
analyzing each of the unstructured data portions to identify at least one tag in each unstructured data portion;
determining a topic for each unstructured data portion based on the identified at least one tag;
analyzing the determined topics to identify at least one match between the topics; and
generating at least one searchable term respective of the at least one match.

2. The method of claim 1, wherein generating at least one searchable term respective of the at least one match further comprises:
correlating the determined topics; and
selecting a most descriptive term based on the correlating.

3. The method of claim 1, wherein analyzing the determined topics to identify at least one match between the topics further comprises:
determining if any portions of the topics are related; and
upon determining that portions of the topics are related, identifying a match between the related portions.

4. The method of claim 1, wherein analyzing each unstructured data portion to identify at least one tag in each portion further comprises:
determining, for each unstructured data portion, at least one textual term within the unstructured data portion;
comparing each of the at least one textual term with a plurality of predetermined textual terms, wherein a tag is assigned to each of the predetermined textual terms; and
upon determining that a textual term of the at least one textual term matches one of the predetermined textual terms, identifying the tag assigned to the matching predetermined textual term.

5. The method of claim 4, further comprising:
upon determining that none of the at least one textual term matches one of the predetermined textual terms, generating a tag based for each of the at least one textual term.

6. The method of claim 4, wherein analyzing each unstructured data portion to identify at least one tag in each portion further comprises:
filtering insignificant textual terms from the at least one textual term.

7. The method of claim 1, wherein determining a topic for each unstructured data portion based on the identified at least one tag further comprises:
comparing the at least one tag of each unstructured data portion to a plurality of combinations of tags to determine at least one context; and
determining the topic based on the context.

8. The method of claim 7, wherein the at least one context is further based on a source of the unstructured data.

9. The method of claim 1, wherein the unstructured data is any of: a document, a message, an image, a video clip, and a calendar event description.

10. A non-transitory computer readable medium having stored thereon instructions for causing one or more processing units to execute the method according to claim 1.

11. A system for cross-cloud topic matching, comprising:
a processing unit; and
a memory, the memory containing instructions that, when executed by the processing unit, configure the system to:
receive unstructured data including at least one unstructured data portion;
analyze each unstructured data portion to identify at least one tag in each unstructured data portion;
determine a topic for each unstructured data portion based on the identified at least one tag;
analyze the determined topics to identify at least one match between the topics; and
generate at least one searchable term respective of the at least one match.

12. The system of claim 11, wherein the system is further configured to:
correlate the determined topics; and
select a most descriptive term based on the correlating.

13. The system of claim 11, wherein the system is further configured to:
determine if any portions of the topics are related; and
upon determining that portions of the topics are related, identify a match between the related portions.

14. The system of claim 11, wherein the system is further configured to:
determine, for each unstructured data portion, at least one textual term within the unstructured data portion;
compare each of the at least one textual term with a plurality of predetermined textual terms, wherein a tag is assigned to each of the predetermined textual terms; and
upon determining that a textual term of the at least one textual term matches one of the predetermined textual terms, identify the tag assigned to the matching predetermined textual term.

15. The system of claim 14, wherein the system is further configured to:
upon determining that none of the at least one textual term matches one of the predetermined textual terms, generate a tag based for each of the at least one textual term.

16. The system of claim 14, wherein the system is further configured to:
filter insignificant textual terms from the at least one textual term.

17. The system of claim 11, wherein the system is further configured to:
compare the at least one tag of each unstructured data portion to a plurality of combinations of tags to determine at least one context; and
determine the topic based on the context.

18. The system of claim 17, wherein the at least one context is further based on a source of the unstructured data.

19. The system of claim 11, wherein the unstructured data is any of: a document, a message, an image, a video clip, and a calendar event description.

20. An agent for cross-cloud topic matching, comprising:
a network interface for receiving and sending unstructured data, the unstructured data including at least one portion of unstructured data;
an analyzing unit for identifying at least one tag respective of each portion of the unstructured data;
a topic determination unit for generating at least one topic respective of each portion of unstructured data; and
a term generator for generating at least one searchable term based on matches between the topics.
